(19) United States
(12) Patent Application Publication
(10) Pub. No.: US 2010/0074702 A1
(43) Pub. Date: Mar. 25, 2010

(54) Spindle drive coupling

(76) Inventor: Douglas J. Kluge, Clearwater, MN (US)

Correspondence Address: Richard John Bartz, Suite 350, 6750 France Avenue South, Edina, MN, 55435, US

(21) Appl. No.: 12/069,012

(22) Filed: Feb. 6, 2008

Related U.S. Application Data
(60) Provisional application No. 60/899,897, filed on Feb. 6, 2007.

(51) Int. Cl. B23B 45/02; E21B 3/02

(52) U.S. Cl. 408/125; 464/182

(57) ABSTRACT

A spindle drive coupling releasably connects a cordless electric motor to an auger assembly used to drill holes in ice on a body of water. The coupling has a sleeve supporting a split head onto the drive shaft of the motor with a clamp assembly.

### CROSS REFERENCE TO RELATED APPLICATION

This application is a continuation of and claims the priority of U.S. Provisional Application Ser. No. 60/899,897 filed Feb. 6, 2007.

### FIELD OF THE INVENTION

The invention relates to drive couplings for connecting cordless electric motors to rotatable auger assemblies used to move fluid-like and solid materials to selected locations.

### BACKGROUND OF THE INVENTION

Ice fishing in winter is a popular outdoor activity in North United States and Canada. Walking onto a frozen lake, drilling holes in the ice, and sitting on a bucket with a jig stick in hand in temperatures below zero is ice fishing, a therapeutic experience. Out on the ice the hassles of work, the to-do lists, taxes, wars and politicians all fade away into the background. A field of ice is a landscape that sears the sin from the soul. Ice augers are used to cut one or more holes in ice on frozen bodies of water. Manual crank augers and motor driven augers operate to cut holes in the ice which can have a thickness of 6 to 30 or more inches.

Auger assemblies are used to transport and convey fluid-like materials, including but not limited to particulate materials, grains, fibers, water, snow and ice particles to desired locations. Conventional auger assemblies have elongated linear shafts with continuous helical flights fixed to the shafts. Power transmissions and motors connected to the shafts operate to rotate the auger assemblies to move the materials along the helical flights. Augers with cutting heads used with hand cranks and internal combustion engines to drill holes in ice on lakes and rivers for ice fishing. These augers have metal construction with high cutting torque that withstands environmental and operator abuse. Metal augers driven with internal combustion engines are bulky, heavy and environmentally detrimental. Weight reduction of auger assemblies and ice drills have been achieved with electric motors connected with cables to portable batteries.

### SUMMARY OF THE INVENTION

The invention's object is to provide an ice fisherperson with a light weight and effective ice drilling machine operated with a cordless electric motor. The electric motor is connected to an auger assembly with a releasable spindle drive coupling that prevents inadvertent separation of the auger assembly from the electric motor. The releasable spindle assembly has a sleeve having a lower end connected to a stud. A releasable fastener connects the stud to the auger assembly. The auger assembly can be a conventional auger having a tubular member secured to a helical flight. Different types, sizes and lengths of auger assemblies can be fastened to the sleeve. The upper end of the sleeve is attached to a split head having upright jaws separated with upright slots. A clamp surrounding the jaws biases the jaws into tight locking engagement with the drive shaft of the electric motor. The clamp has two C-shaped members and bolts retaining the C-shaped members around the jaws. The bolts must be released to remove the drive shaft of the motor. A modification of the spindle drive coupling has a split head mounted on a threaded upper end of the sleeve. A collar threaded on the upper end of the sleeve retains the split head on the sleeve. The spindle drive couplings permit the user to adapt various types of auger assemblies and other tools to a conventional cordless electric motor. The cordless electric motor can be easily removed from the spindle drive coupling and used with a chuck in the work environment.

### DESCRIPTION OF DRAWING

FIG. 1 is a perspective view of the spindle drive coupling of the invention connected to a cordless electric motor and an auger assembly for cutting a hole in a solid object;

FIG. 2 is an exploded perspective view of FIG. 1;

FIG. 3 is an enlarged foreshortened front elevational view of the sleeve of the spindle drive coupling of FIG. 1;

FIG. 4 is a top plan view of FIG. 3;

FIG. 5 is a sectional view taken along line 5-5 of FIG. 3;

FIG. 6 is a sectional view taken along line 6-6 of FIG. 3;

FIG. 7 is an enlarged sectional view taken along line 7-7 of FIG. 1;

FIG. 8 is a sectional view taken along line 8-8 of FIG. 7;

FIG. 9 is a sectional view taken along line 9-9 of FIG. 8;

FIG. 10 is an enlarged sectional view taken along line 10-10 of FIG. 1;

FIG. 11 is a perspective view of a modification of the spindle drive coupling of the invention connected to a cordless electric motor and an auger assembly for cutting a hole in a solid object;

FIG. 12 is an enlarged side elevational view of the sleeve of the spindle drive coupling of FIG. 11;

FIG. 13 is an enlarged top plan view of FIG. 12;

FIG. 14 is an enlarged sectional view taken along line 14-14 of FIG. 12;

FIG. 15 is an enlarged front elevational view of the releasable device connecting the drive shaft of the electric motor to the sleeve;

FIG. 16 is an enlarged sectional view taken along line 16-16 of FIG. 11;

FIG. 17 is a sectional view taken along line 17-17 of FIG. 15; and

FIG. 18 is a sectional view taken along line 18-18 of FIG. 15.

### DETAILED DESCRIPTION OF THE INVENTION

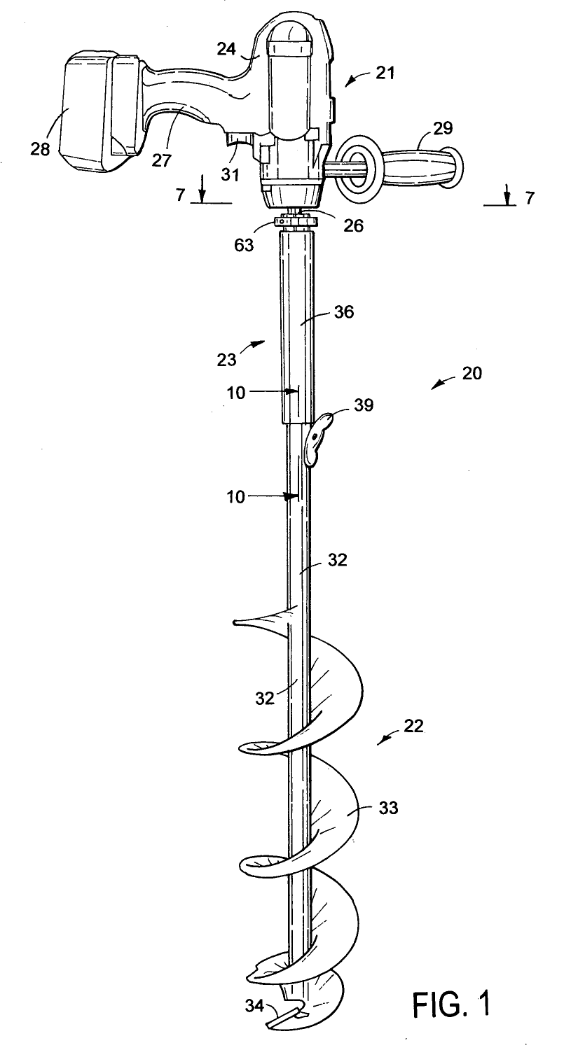

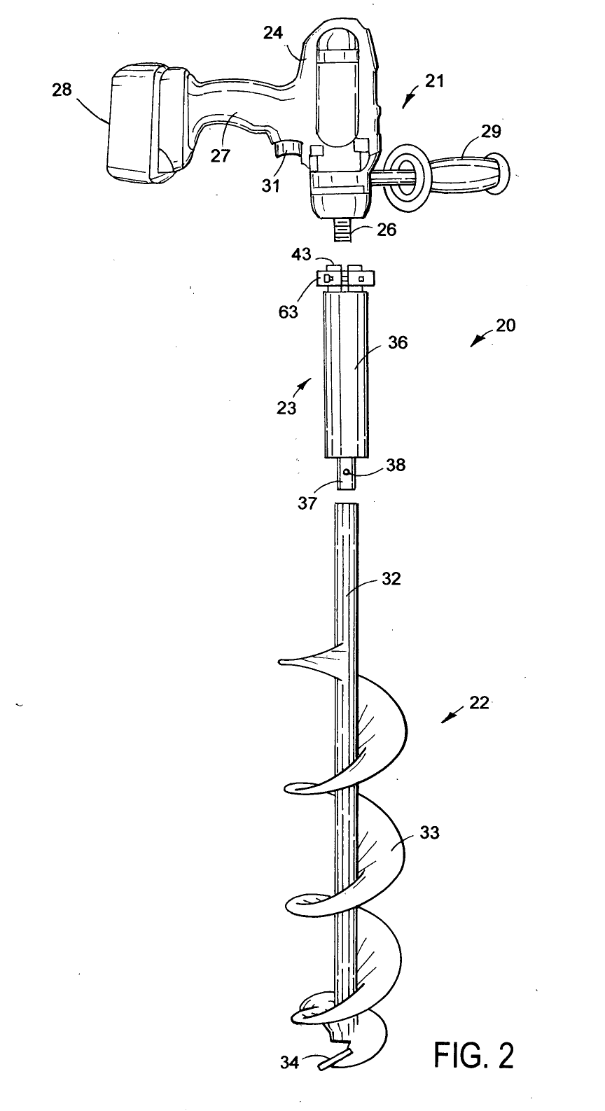

As shown in FIGS. 1 and 2, a power tool 20 is equipped with a spindle drive coupling 23 that allows a cordless electric motor 21 to be releasably attached to the coupling to allow electric motor 21 to be used for other purposes. Spindle drive assembly 23 connects electric motor 21 to an auger assembly 22. Motor 21 is a conventional d.c. electric motor having a housing 24 joined to a lateral arm 27. Motor 21 has a downwardly extended threaded drive shaft 26. The conventional Jacobs chuck has been removed from shaft 26. A battery 28 is mounted on the outer end of arm 27. One type of battery is a 36 volt lithium battery pack. Other types of power supplies and batteries can be used to operate motor 21. Battery 28 provides the energy necessary to rotate auger assembly 22 to drill an ice fishing hole in ice on a body of water. Power tool 20 with electric motor 21 is a lightweight, quiet, fast and efficient drilling machine. Power tool 20 is environmentally advantageous as it does not have an internal combustion engine that uses gasoline and oil. A lateral handle 29 attached to motor housing 24 generally opposite arm 27 is used by the operator of power tool 20 with arm 27 to retain power tool 20 in an upright position during drilling in particulates, fluid and solid materials including ice on a body of water. A trigger 31 mounted on arm 27 is used to control the operation and speed of motor 21. Motor 21 is a conventional electric drill that can be removed from spindle drive coupling 23 and used with a chuck for holding cutting and grinding tools.

Auger assembly 22 is a conventional auger with a cutting blade used with hand cranks and internal combustion engines to drill holes in ice on a body of water for ice fishing. Auger assembly 22 has a linear tubular member or core 32. A continuous helical flight 33 is secured with welds to core 32. The bottom of flight 33 supports a cutting blade. The upper end of core 32 telescopes over a stud 37 extended downwardly from the bottom of a tubular sleeve 36. As shown in FIG. 10, stud 37 has a transverse hole 38 accommodating a wing head bolt 39. Bolt 39 has threads 41 that retain bolt 39 in assembled relationship with core 32 and stud 37. Stud 37 extends in the lower end of sleeve 36. Bonding material 42 maintains stud 37 on sleeve 36. Bolt 39 can be removed from sleeve 32 and stud 37 to allow auger assembly 22 to be removed from stud 37. Other types of fasteners can be used to connect auger assembly 22 to sleeve 36. Auger assemblies having different diameters and lengths can be attached to stud 37 with bolt 39. Other types of tools, such as polishing pads, sanding disks and cutting tools can be mounted on stud 37.

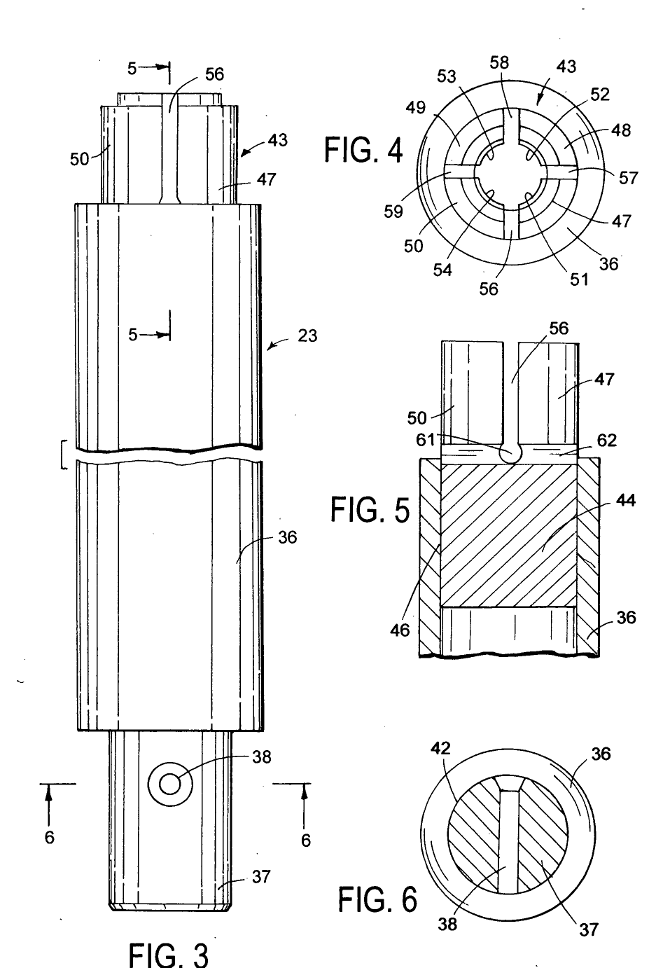

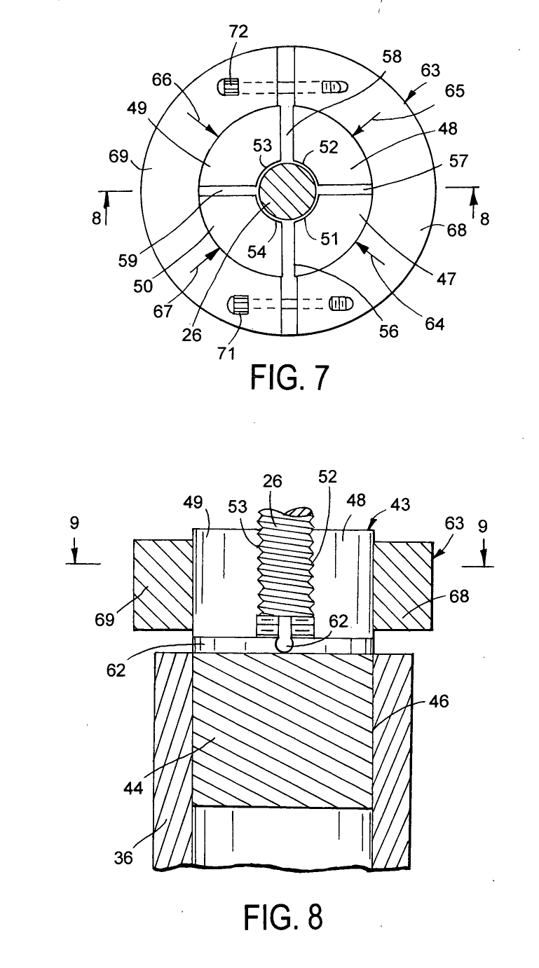

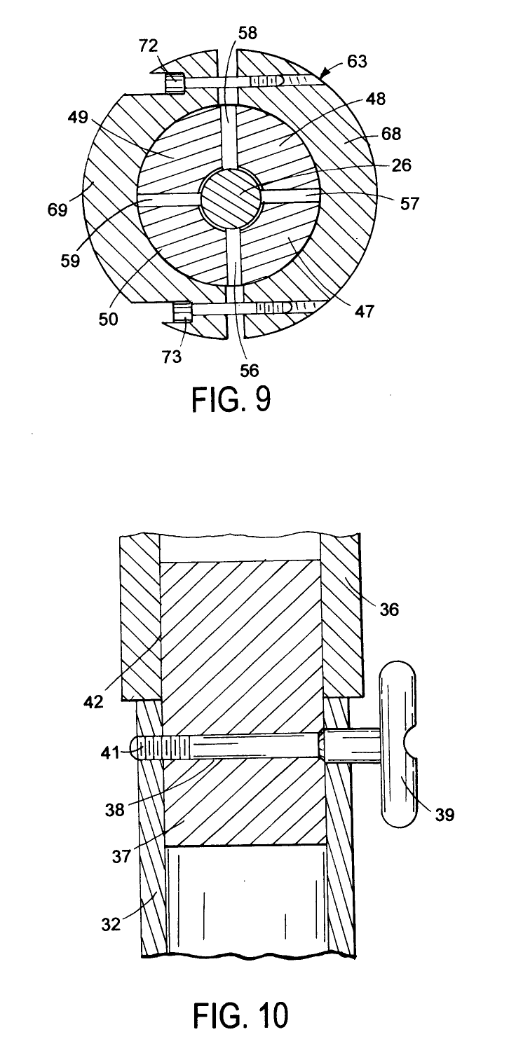

As shown in FIGS. 3 to 8, a split head 43 having a cylindrical body 44 is mounted on the top end of sleeve 36. Bonding material 46 secures body 44 to the inside wall of sleeve 36. Head 43 has four upright members or jaws 47, 48, 49 and 50 having inner threaded arcuate sections 51, 52, 53 and 54 adapt to engage and lock on threaded drive shaft 26 of motor 21. Radial slots 56, 57, 58 and 59 separate adjacent jaws 47-50. As seen in FIG. 5, cross bores 61 and 62 at the bottoms of slots 56-59 having diameters greater than the widths of slots 56-59 reduce stress edges at the bottom of jaws 47-50. A clamp assembly 63 surrounding jaws 47-50 applies inward radial forces on jaws 47-50, as shown by arrows 64, 65, 66 and 67 in FIG. 7, to lock jaws 47-50 on drive shaft 26 of motor 21. Clamp assembly 63 has first and second C-shaped members 68 and 69, as shown in FIGS. 7 and 8, engageable with the outside walls of split head jaws 47-50. A pair of threaded bolts 71 and 72 connect opposite ends of C-shaped members 68 and 69. Bolts are turned tight to apply clamping forces on jaws 47-50 to lock jaws 47-50 on drive shaft 26 whereby motor 21 rotates split head 43, body 44 and sleeve 36 and auger assembly 22 secured to sleeve 36.

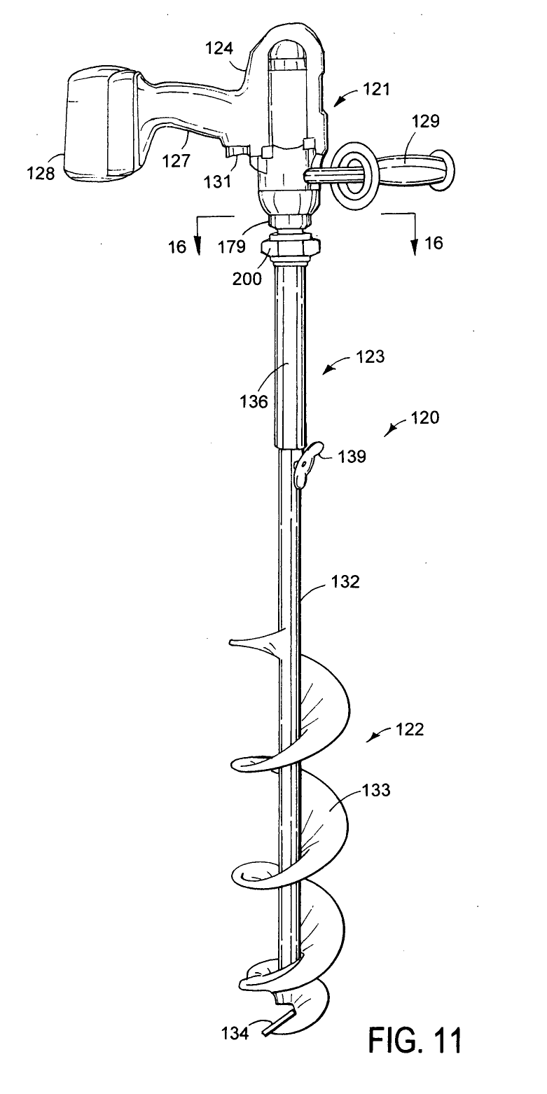

A modification of the spindle drive coupling 123, shown in FIG. 11, connects a cordless electric motor 121 to an auger assembly 122. Motor 121 is a conventional d.c. electric motor having a housing 124 joined to a lateral arm 127 supporting a battery 128. Battery 128 is a 36 volt lithium ion battery pack removably mounted on the outer end of arm 127. Other types of batteries and power supplies can be used to operate motor 121. A manual trigger 131 mounted on arm 127 is operable to connect motor 121 with battery 128 to operate and control the speed of motor 121 and rotate the motor driven shaft 126. Shaft 126 is a threaded cylindrical member that is normally attached to a conventional Jacobs chuck used to hold a tool, such as a drill, ream or tap. The chuck has been removed from shaft 126. A lateral handle 129 attached to motor housing 124 generally opposite arm 127 is used by the operator of motor 121 in conjunction with arm 127 to retain auger assembly 122 in an upright position during drilling in particulate, fluid and solid materials including ice on a body of water. Motor 121 and battery 128 is a conventional cordless power tool that can be removed from spindle drive coupling 123 and used with a chuck for holding cutting and grinding tools.

Spindle drive coupling 123 connects motor shaft 126 to a conventional auger assembly 122. Auger assembly 122 has a linear member or tubular core 132. A continuous helical flight 133 is secured with welds to core 132. A cutting blade 134 is attached to the bottom portion of helical flight 133. The upper end of core 132 telescopes over a stud 137 in the lower end of a sleeve 136. A wing bolt 139 extended through a hole 138 in stud 137 connects core 132 to stud 137. Bolt 139 can be removed from stud 137 and core 132 to allow auger assembly 122 to be removed from spindle drive coupling 123. Other types of fasteners can used to connect auger assembly 122 to sleeve 136. Auger assemblies having different diameters and lengths can be attached to stud 137 with bolt 139.

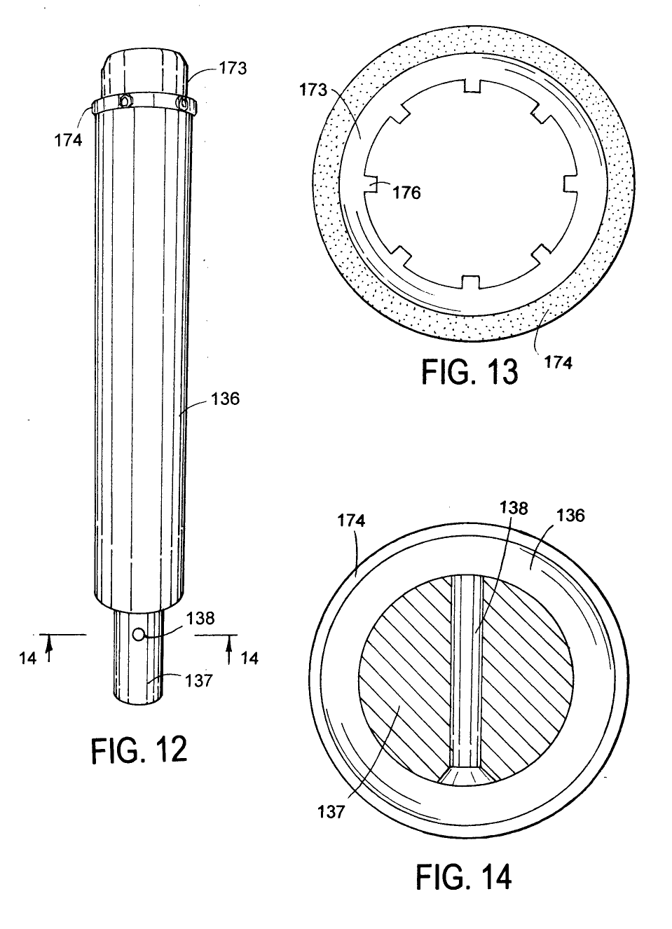

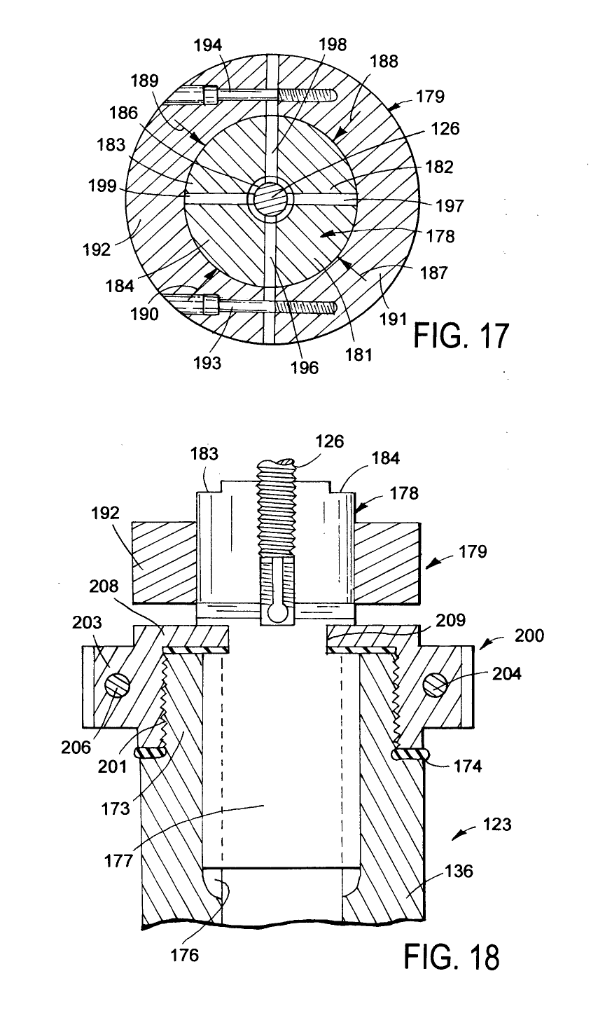

As shown in FIG. 12, sleeve 136 has a threaded upper end 173. An annular flexible plastic washer or ring 174 surrounding end 173 frictionally engages a collar 200 threaded on end 173 to prevent collar 200 from turning off end 173. The upper end 173 of sleeve 136 has a plurality of internal ribs or splines 176, shown in FIGS. 13 and 18, that cooperate with grooves in a body 177 joined to a split head 178. A clamp assembly 179 locks split head 178 onto shaft 126 of motor 121 to prevent drive coupling 123 and auger assembly 122 from separating from motor 121 and falling through an ice hole to the bottom of the body of water. Split head 178 has four upright jaws or members 181, 182, 183 and 184 having inside threads 186 that engage and lock on the threads of shaft 126 of motor 121. Radial slots 196, 197, 198 and 199 extend longitudinally into head 178 separating adjacent jaws. Cross bores at the bottoms of the slots having diameters greater than the widths of slots 196-199 reduce stress edges at the bottom of the jaws. Clam assembly 179 surrounds jaws 181-184 and applies inward radial forces on jaws 181-184, as shown by arrows 187, 188, 189 and 190 in FIG. 17. Clamp assembly 179 has first and second C-shaped members 191 and 192 engageable with the outside walls of split head 178. A pair of threaded bolts 193 and 194 connect opposite ends of members 191 and 192. Bolts 193 and 194 are turned tight to apply clamping forces on jaws 181-184 to lock jaws 181-184 on shaft 126 of motor 121 whereby motor 121 rotates split head 178, body 177 and sleeve 136.

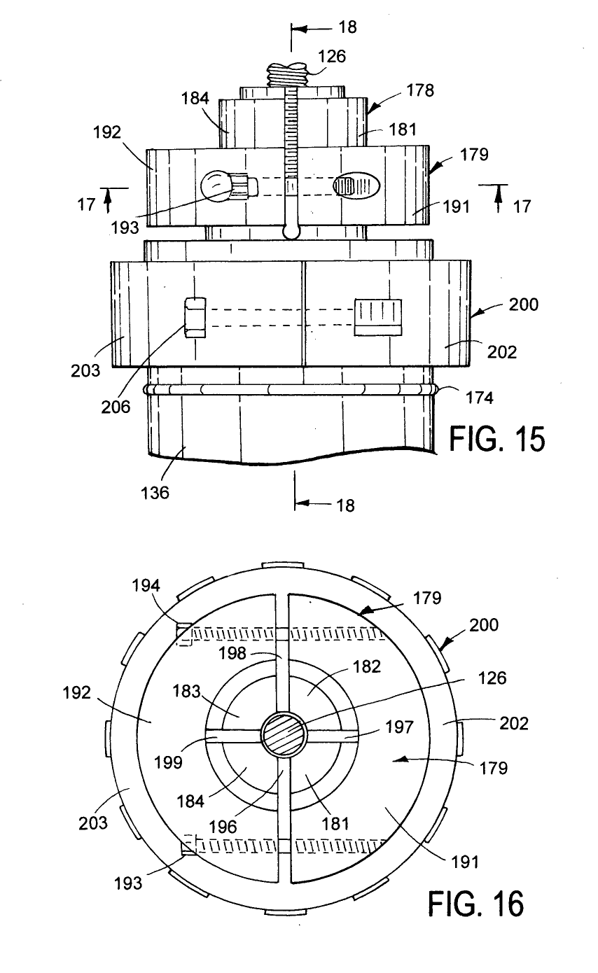

As shown in FIGS. 15, 16 and 18, a collar 200 with internal threads 201 is threaded on upper end 173 of sleeve 136 to retain body 177 within end 173. Collar 200 has two C-shaped members 202 and 203 joined with threaded bolts 204 and 206. Inwardly directed flanges 207 and 208 on collar 200 extend into an annular groove 209 above body 177 to axially hold collar 200 on body 177 and allow collar 200 to rotate relative to body 177 whereby collar 200 can be threaded on and off of end 173 of sleeve 136.

The advantages and details of structures and functions of the preferred embodiments of the spindle drive coupling have been disclosed. They are exemplary and other equivalents are feasible. Therefore, changes in shape, size, elements and arrangement of the cordless motor, spindle drive coupling and auger assembly can be made by a person skilled in the art within the scope of the invention.

1. A drive coupling for connecting a drive shaft of a motor to an auger assembly comprising:
a sleeve having an upper end and a lower end;
a member secured to the lower end adapted to be connected to the auger assembly;
a fastener for connecting the member to the auger assembly;
a split head secured to the upper end of the sleeve adapted to be connected to the drive shaft of the motor; and
a clamp surrounding the split head operable to lock the split head on the drive shaft of the motor.

2. The drive coupling of claim 1 wherein: the split head includes
a plurality of upright jaws surrounding the drive shaft of the motor; and
a plurality of upright slots in said head separating adjacent jaws;
said clamp surrounding the jaws and operable to bias the jaws into locking engagement with the drive shaft of the motor.

3. The drive coupling of claim 1 wherein: the member comprises
a stud extended into the lower end of the sleeve;
said stud having a hole accommodating the fastener connecting the stud to the auger assembly.

4. The drive coupling of claim 3 wherein: the fastener is a bolt extended through the hole in the stud.

5. The drive coupling of claim 1 including:
a body extended into the upper end of the sleeve;
said body being joined to the split head whereby the split head is secured to the sleeve.

6. The drive coupling of claim 1 wherein: the clamp includes
a pair of C-shaped members surrounding the split head; and
fasteners connecting the C-shaped member and operable to bias the split head into locking engagement with the drive shaft of the motor.

7. The drive coupling of claim 1 wherein: the split head includes
a plurality of upright jaws surrounding the drive shaft of the motor;
a plurality of upright slots in said head separating adjacent jaws;
said clamp including a pair of C-shaped members surrounding said jaws; and
fasteners connecting the C-shaped members and operable to bias the jaws into locking engagement with the drive shaft of the motor.

8. The drive coupling of claim 1 wherein:
said sleeve has a threaded upper end; and
a collar threaded on the upper end of the sleeve for holding the split head on the sleeve.

9. The drive coupling of claim 1 including:
a body joined to the split head;
cooperating members on the body and sleeve to drivably connect the body to the sleeve; and
a collar retained on the sleeve for holding the body on the sleeve.

10. A power tool for cutting a hole in an object comprising:
a cordless electric motor having a drive shaft and a battery to supply electric power to the motor;
an auger assembly having a core and helical flight secured to the core;
a drive coupling for connecting the drive shaft of the motor to the core of the auger assembly, said coupling comprising;
a sleeve having an upper end and a lower end;
a member secured to the lower end of the sleeve;
a fastener connecting the core of the auger assembly to the member;
a split head secured to the upper end of the sleeve surrounding the drive shaft of the motor; and
a clamp surrounding the split head operable to lock the split head on the drive shaft of the motor.

11. The power tool of claim 10 wherein: the split head includes
a plurality of upright jaws surrounding the drive shaft of the motor; and
a plurality of upright slots in said head separating adjacent jaws;
said clamp surrounding the jaws and operable to bias the jaws into locking engagement with the drive shaft of the motor.

12. The drive coupling of claim 10 wherein: the member comprises
a stud extended into the lower end of the sleeve;
said stud having a hole accommodating the fastener connecting the stud to the auger assembly.

13. The power tool of claim 10 including:
a body extended into the upper end of the sleeve;
said body being joined to the split head whereby the split head is secured to the sleeve.

14. The power tool of claim 10 wherein: the clamp includes
a pair of C-shaped members surrounding the split head; and
fasteners connecting the C-shaped member and operable to bias the split head into locking engagement with the drive shaft of the motor.

15. The power tool of claim 10 wherein: the split head includes
a plurality of upright jaws surrounding the drive shaft of the motor;
a plurality of upright slots in said head separating adjacent jaws;
said clamp including a pair of C-shaped members surrounding said jaws; and
fasteners connecting the C-shaped members and operable to bias the jaws into locking engagement with the drive shaft of the motor.

16. The power tool of claim 10 wherein:
said sleeve has a threaded upper end; and
a collar threaded on the upper end of the sleeve for holding the split head on the sleeve.

17. The power tool of claim 10 including:
a body joined to the split head;
cooperating members on the body and sleeve to drivably connect the body to the sleeve; and
a collar retained on the sleeve for holding the body on the sleeve.
